(19) United States
(12) Patent Application Publication
(10) Pub. No.: US 2013/0186671 A1
(43) Pub. Date: Jul. 25, 2013

(54) SLEEVES FOR ELECTRICAL WIRING AND METHODS OF IDENTIFYING ELECTRICAL WIRING

(71) Applicant: Greg E. Theis, St. Cloud, MN (US)

(72) Inventor: Greg E. Theis, St. Cloud, MN (US)

(21) Appl. No.: 13/734,558

(22) Filed: Jan. 4, 2013

Related U.S. Application Data
(60) Provisional application No. 61/582,939, filed on Jan. 4, 2012.

(51) Int. Cl. H01B 7/36

(52) U.S. Cl. CPC H01B 7/365
USPC 174/112

(57) ABSTRACT

A covering or sleeve can include an insulating material, such as a polymeric material, that is permanently printed with indicia identifying the particular circuit to which a wire belongs. In an embodiment, the sleeve is printed to permanently mark the sleeve with indicia identifying the room or space the covered electrical wire is sourcing. The sleeves can optionally be color-coded as a secondary identification system according to known color-coding in the industry. The printed sleeves can be sold individually and then subsequently applied to the electrical wires at the electrical source, such as an electrical box. In another embodiment, wiring can be covered with the printed sleeves and packaged individually, or in a set, such as on an electrical panel. In other embodiments, methods of identifying electrical wiring are disclosed.

### RELATED APPLICATION

The present application claims the benefit of U.S. Provisional Application No. 61/582,939, filed Jan. 4, 2012, which is incorporated herein in its entirety by reference.

### FIELD OF THE INVENTION

The present invention relates generally to identification of electrical wiring, and more particularly to printed sleeves for identification of electrical wiring, and methods of identifying electrical wiring.

### BACKGROUND OF THE INVENTION

For the efficiency of electricians it is helpful to identify, at the electricity supply system, which electrical wiring or bundles of wiring belongs to a particular circuit. For example, easy identification at a fuse box or circuit breaker of the wiring to the kitchen, bedroom, living room, or any other room or space in a structure is desired to save time and money when working with the electricity supply system. Such identification allows electricians the ability to pinpoint a particular circuit without resorting to guesswork or trial-and-error, which can be time-consuming, costly, and dangerous.

Traditional electrical wiring is protected by a covering, such as a plastic sleeve. Individual wires can be covered, or bundles of wires may be encased in a single sleeve. Currently in the profession, electricians may mark these coverings or sleeves with a temporary or non-permanent marking, such as a pen or marker that can wear over time, rendering the marking intelligible, or with an adhesive label that can lose its adhesiveness and fall off over time, leaving the previously-labeled wiring unlabeled. Furthermore, it can be difficult to label the wires when already installed in an electrical panel, or encased in a sleeve. Color coded sleeves are also available; however, the color coding must be known or otherwise available to the electrician to decipher where the wire is to be sourced.

Thus, there remains a need for a system of permanent marking or identification of the electrical wires and a method of identifying the electrical wires that do not suffer the drawbacks of the prior art systems and methods.

### SUMMARY OF THE INVENTION

Embodiments of the present invention overcome many of the drawbacks of the prior art. A covering or sleeve according to embodiments of the invention generally can comprise an insulating material, such as a polymeric material, that is permanently printed with indicia identifying the particular circuit to which the wire belongs. In one particular embodiment, the sleeve is printed using a permanent printing technique such as inkjet printing to permanently mark the sleeve with indicia identifying the room or space the covered electrical wire is sourcing. Permanent printing techniques can include pad printing, lithographic printing, flexographic printing, gravure printing, and digital printing including ink jet printing, in-line ink jet printing, electrographic printing, or laser printing, for example. The sleeves can optionally be color-coded as a secondary identification system according to known color-coding in the industry.

The printed sleeves can be sold individually and then subsequently applied to the electrical wires at the electrical source, such as an electrical box. This can be done using a heat shrinkable material in which the sleeve material is wrapped over the appropriate electrical wire or wires, and then heat is applied such as by a heat gun to seal the sleeve over the wire or wires. Other attachment means can also be contemplated such as adhesive, mechanical fasteners, or the like. Alternatively, wiring can be covered with the printed sleeves and packaged individually, or in a set. For example, electrical wiring for a house can be sold as a package including marked wiring for a kitchen, bedrooms, living room, etc. In this embodiment, the covering material may be extruded unto the electrical wiring and then the wiring is cut into a plurality of covered wires, and subsequently printed using a permanent printing technique, such as lithographic printing, flexographic printing, gravure printing, and digital printing including ink jet printing, in-line ink jet printing, electrographic printing, or laser printing, for example.

In an embodiment, the electrical wiring for a house can be packaged in a kit including a plurality of identifying sleeves, instructions for instructing a user to install the plurality of identifying sleeves at an electrical supply source of the structure, and a container for storing the plurality of identifying sleeves and the instructions. In another embodiment, the kit can further comprise a plurality of electrical wires, wherein each of the plurality of identifying sleeves is pre-wrapped around one or more of the plurality of electrical wires. In another embodiment, the kit can further comprise an electrical panel or breaker box having the plurality of identified electrical wires installed, wherein the container is further configured to store the electrical panel or breaker box. Thus, the entire wiring set or electrical panel can come pre-labeled.

In another embodiment of the invention, a method of identifying electrical wiring can include accessing an electrical system, such as an electrical box, having a plurality of wires, each wire belonging to a particular circuit, and covering one or more electrical wires of the plurality of electrical wires, the electrical wire having an insulating sleeve or cover, the sleeve or cover including a permanent marking indicating a particular circuit to which the electrical wire belongs. In another embodiment, the sleeve or cover is of a standardized color for indicating a particular circuit to which the electrical wire belongs. For example, in embodiments, yellow indicates bath outlet, washing machine, dining outlet, and kitchen outlet circuits. Orange indicates dryer, cooktop, built-in oven, air conditioner, and water heater circuits. White indicates 15 amp circuits throughout the house, including but not limited to bedrooms, hallways, and smoke detectors. Black indicates range circuits.

Alternatively, a method of identifying electrical wiring can include accessing an electrical system, such as an electrical box, installing a plurality of electrical wires, each wire having an insulating sleeve or cover, the sleeve or cover including a permanent marking indicating a particular circuit to which the electrical wire belongs. In another embodiment, the sleeve or cover is of a standardized color for indicating a particular circuit to which the electrical wire belongs. Therefore, in embodiments, the electrical system can then be subsequently accessed, even after long periods of time, and the particular circuits to which the covered wires belong are easily identified.

In another embodiment, a method of identifying electrical wiring in an electrical panel can include accessing an electrical panel, such as a fuse box having a plurality of wires, each wire belonging to a particular circuit and being covered by a sleeve or cover, the sleeve or cover including a permanent marking, standardized color, or combination thereof indicating a particular circuit to which the electrical wire belongs, analyzing said sleeve or cover, and linking a particular circuit to a location in the building containing the electrical panel.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of an identifying sleeve covering an electrical wire, according to an embodiment.

FIG. 2 is a block diagram of an electrical panel having identifying sleeves covering electrical wiring, according to an embodiment.

FIG. 3 is a perspective view of a plurality of identifying sleeves without printed indicia, according to an embodiment.

FIG. 4 is another perspective view of a plurality of identifying sleeves without printed indicia of FIG. 3, according to an embodiment.

FIG. 5 is a flowchart of a method of identifying electrical wiring, according to an embodiment.

FIG. 6 is a flowchart of a method of identifying electrical wiring, according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

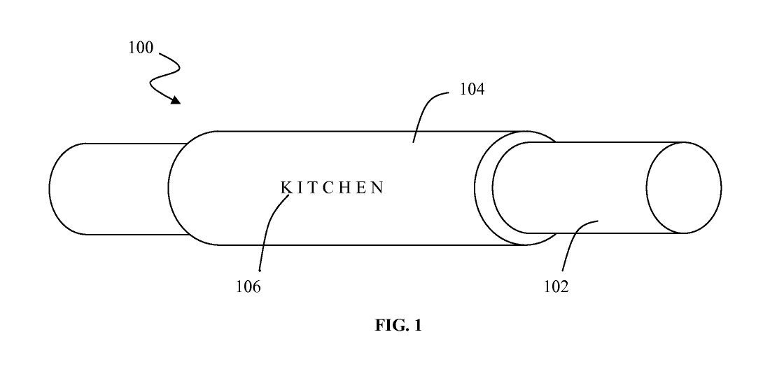

Referring to FIG. 1, an identified electrical wire 100 according to an embodiment is depicted. Identified electrical wire 100 generally includes wire 102 and identifying sleeve 104.

Wire 102 comprises an individual electrical wire or a bundle of wiring belonging to a single circuit. In an embodiment, wire 102 generally comprises an insulated conductor used to carry electricity. In another embodiment, wire 102 can comprise a plurality of individual electrical wires. While the embodiments herein are described for simplicity and illustration with respect to electrical wiring, the concepts are likewise applicable to other types of wiring where a large collection of wires are present at a single location, such as network wiring like coaxial cable, optical fiber, and twisted pair wiring. In embodiments, wire 102 is typically installed throughout a building such as a single family home or apartment building, or equivalent commercial space, with a central panel for accessing the individual wires 102.

Identifying sleeve 104 provides a device for identifying, sourcing, or otherwise linking wire 102 to a particular circuit. Generally, identifying sleeve 104 comprises a cylinder having an outer surface formed by the points at a fixed distance from the axis of the cylinder. As such, the surface is bookended by an aperture at each end of the cylinder. In various embodiments, the surface radius is variable, depending on the wire 102 application. For example, in embodiments where the surface radius is defined by a heat-shrunk coating, the surface radius can be very small. In other embodiments where a bundle of wires 102 is enclosed, the surface radius can be substantial to account for the bulging of the bundle of wires 102.

Identifying sleeve 104 can comprise an insulating material, such as a polymeric material, that is wrapped around or encompasses wire 102. In other embodiments, identifying sleeve 104 can comprise a heat shrinkable coating in which the sleeve coating is wrapped over electrical wire 102, whereby heat is then applied to seal sleeve 104 over wire 102. In other embodiments, identifying sleeve 104 comprises a plastic-based jacket. In other embodiments, identifying sleeve 104 is friction-fitted over wire 102. Attachment means such as adhesive fasteners or mechanical fasteners are also considered. Therefore, depending on the application, identifying sleeve 104 can be adhered, fastened, or otherwise secured to wire 102, or positioned such that a friction fit secures sleeve 104 onto wire 102. In other embodiments where the ends of wire 102 are anchored, sleeve 104, once fitted over wire 102, can move about freely along wire 102, because of the secure anchoring of the ends of wire 102.

Identifying sleeve 104 can be of varying lengths. For example, in embodiments, an identifying sleeve 104 can have a length six to eight times the cylinder radius. Such a sleeve 104 is appropriate for longer lengths of wire 102. In embodiments, longer sleeves are also useful in longer indicia 106 identification. In other embodiments, a shorter length of wire 102 can include a corresponding shorter length of sleeve 104 such that sleeve 104 has a shorter length surface between the two apertures to embody a ring rather than an elongated cylinder. The examples of lengths provided herein are for illustration only; in no way are the above-listed lengths limiting in any way.

Indicia 106 comprises text or other identifying markings that convey a source of the electrical wire 102 that identifying sleeve 104 is encompassing. For example, as illustrated by identified electrical wire 100 in FIG. 1, indicia 106 comprises the word “KITCHEN” to signify that wire 102 is sourced at the kitchen of the building. In an embodiment, sleeve 104 is printed using pad printing to permanently mark sleeve 104 with indicia 106 identifying the room or space the covered electrical wire is sourcing. Where appropriate, in embodiments, other identifying or additional informational notations can be printed as part of indicia 106.

Indicia 106 can be formed from permanent marking material compatible with the printing technique utilized for printing indicia 106. For example, the printing technique can include traditional contact-based printing such as, for example, lithographic, flexographic, gravure and the like, which utilizes solvent-based or solvent-less inks or dyes. In other embodiments, plate-less or die-less digital printing techniques, including both contact and contactless can be utilized, including inkjet printing, drop-on-demand printing, electrographic printing, laser printing, thermal printing, and the like, in which digital printing inks (solvent-based or solvent-less) and/or toners are used. In another embodiment, thermal transfer printing is utilized in which no ink or toner is employed. Rather, a heat-sensitive ribbon passes under a thermal print head. A coating of the ribbon is selectively melted in the image area and transfers to the sleeve and bonds thereon. Optionally, when a heat-shrinkable material is used for the sleeve, the thermal print head can also act to seal the sleeve over the wire. In another embodiment, pad printing is utilized. Pad printing is a printing process that can transfer a 2-D image onto a 3-D object. This is typically accomplished using an indirect offset (gravure) printing process that involves an image being transferred from a stereoplate or cliché via a silicone pad onto a substrate. In any of the printing techniques used above, the printing medium permanently bonds or otherwise adheres to the sleeve such that it is virtually wear resistant and permanent.

Sleeve 104 can optionally be color-coded as a secondary identification system according to known color-coding in the industry, or definable unique color coding for a particular building, if desired. For example, identifying sleeve 104 can comprise a material that is colored yellow to signify the kitchen circuit. To account for the variable lengths of identifying sleeve 104, indicia 106 and the color-coding can be adapted to fit on longer or shorter lengths of identifying sleeve 104. For example, an identifying sleeve 104 having a yellow color with abbreviated indicia 106, such as the first letter of a location—“K” for “Kitchen”—on a shorter length of identifying sleeve 104 can provide adequate identifying information as a longer length of identifying sleeve 104 where the entire “Kitchen” can be printed.

In an embodiment, production of sleeve 104 readily enables mass quantity output. For example, sleeve 104 can comprise a substantial length of insulated tubing spooled for easy storage prior to indicia 106 printing. Upon the unspooling of the tubing, a printer can imprint the same indicia 106 repeatedly over spaced-apart sections of the tubing. Subsequently, the tubing can be cut or scored at the spaced sections to thereby create sleeve 104. Because the cutting will be at known lengths, and, in embodiments, corresponding to the length of the printed indicia, the tubing can be fed through a machine tasked with cutting at a set length. As a result, large quantities of sleeves 104 can be created efficiently and cost-effectively. Alternatively, the printed tubing can be supplied to an end user. The end user can cut the tubing to a desired length using a scissors, box cutter, or any other suitable cutting device.

In another embodiment, the tubing of sleeve 104 can be spooled with wire 102, the sleeve 104 having already been wrapped around wire 102. Similar to the above production of sleeve 104, the insulated tubing wrapped around wire 102 can be unspooled. A printer can then imprint the same indicia 106 repeatedly over spaced-apart sections of the tubing wrapped around wire 102. Wire 102 (and tubing) can then be cut at the spaced apart sections to create identified electrical wire 100, as described above. Likewise, large quantities of identified electrical wire 100 can be created. Alternatively, similar to the tubing-only example given above, the tubing wrapped around wire 102 can be supplied to an end user. The end user can cut the wire 102 (and sleeve 104) to a desired length using a wire cutter or any other suitable device.

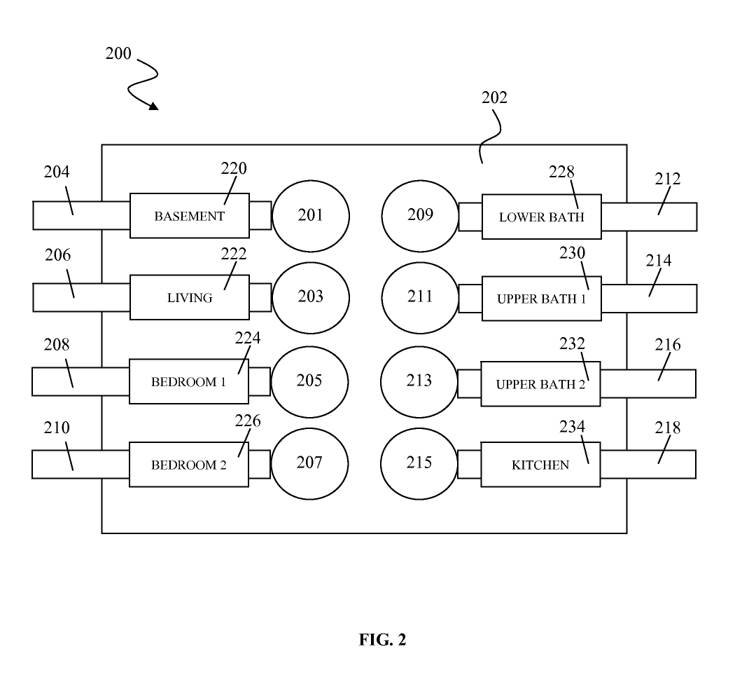

Referring to FIG. 2, multiple identified electrical wires 100 are utilized as part of the wiring to an electrical panel 200, and are described with unique reference numerals for each identified wire for clarity. Electrical panel 200 generally comprises box 202, which holds a plurality of wires, sleeves, and terminals. Specifically, wire 204 extends from terminal 201. Terminal 201 forms the point at which connections can be made to the electrical wiring of a basement of the structure. Similarly, wire 206 extends from terminal 203. Terminal 203 forms the point at which connections can be made to the electrical wiring of the living room of the structure. Wire 208 extends from terminal 205. Terminal 205 forms the point at which connections can be made to the electrical wiring of a first bedroom of the structure. Wire 210 extends from terminal 207. Terminal 207 forms the point at which connections can be made to the electrical wiring of a second bedroom of the structure. Wire 212 extends from terminal 209. Terminal 209 forms the point at which connections can be made to the electrical wiring of a bathroom on a lower floor of the structure. Wire 214 extends from terminal 211. Terminal 211 forms the point at which connections can be made to the electrical wiring of a first upper bathroom of the structure. Wire 216 extends from terminal 213. Terminal 213 forms the point at which connections can be made to the electrical wiring of a second upper bathroom of the structure. Finally, wire 218 extends from terminal 215. Terminal 215 forms the point at which connections can be made to the electrical wiring of a kitchen of the structure.

Without accompanying indentifying sleeves, the aforementioned wiring would appear identical within electrical panel 200. Once installed, it would be difficult to identify particular circuits without guesswork or trial-and-error. However, and as depicted in FIG. 2, each of the aforementioned circuits is labeled with a corresponding sleeve. Specifically, sleeve 220 has indicia reading “BASEMENT.” Sleeve 220 is positioned around and adhered to wire 204 to signify that terminal 201 and corresponding wire 204 are linked to the basement wiring. Sleeve 222 has indicia reading “LIVING.” Sleeve 222 is positioned around and adhered to wire 206 to signify that terminal 203 and corresponding wire 206 are linked to the living room wiring. Sleeve 224 has indicia reading “BEDROOM 1.” Sleeve 224 is positioned and adhered to wire 208 to signify that terminal 205 and corresponding wire 208 are linked to the first bedroom wiring. Sleeve 226 has indicia reading “BEDROOM 2.” Sleeve 226 is positioned and adhered to wire 210 to signify that terminal 207 and corresponding wire 210 are linked to the second bedroom wiring. Sleeve 228 has indicia reading “LOWER BATH.” Sleeve 228 is positioned and adhered to wire 212 to signify that terminal 209 and corresponding wire 212 are linked to the lower bathroom wiring. Sleeve 230 has indicia reading “UPPER BATH 1.” Sleeve 230 is positioned and adhered to wire 214 to signify that terminal 211 and corresponding wire 214 are linked to the first upper bathroom wiring. Sleeve 232 has indicia reading “UPPER BATH 2.” Sleeve 232 is positioned and adhered to wire 216 to signify that terminal 213 and corresponding wire 216 are linked to the second upper bathroom wiring. Sleeve 234 has indicia reading “KITCHEN.” Sleeve 234 is positioned around and adhered to wire 218 to signify that terminal 215 and corresponding wire 218 are linked to the kitchen wiring. In embodiments, sleeves 220, 222, 224, 226, 228, 230, 232, and 234 are also color-coded to correspond to a standardized color scheme or, alternatively, a definable color scheme for that particular building.

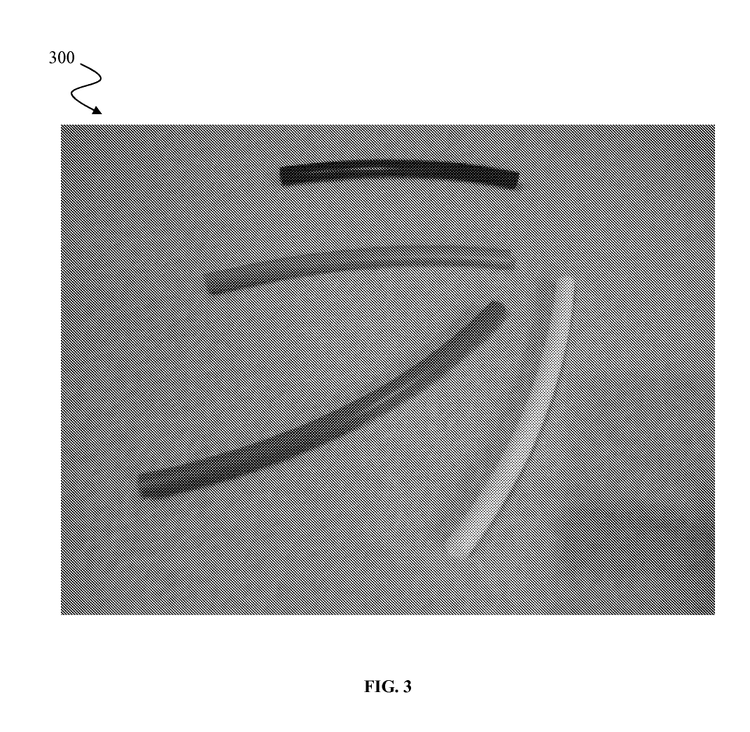

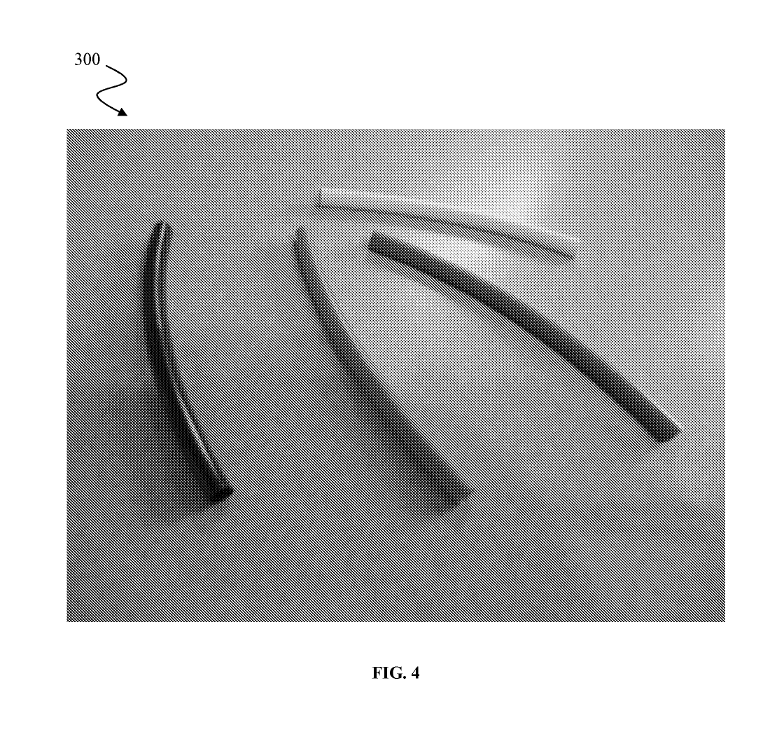

Referring to FIGS. 3 and 4, a plurality 300 of sleeves 104 are depicted prior to being printed with labeling indicia 106. In the embodiment illustrated, sleeves 104 are of a sleeve jacket type. Such sleeves 104 can be printed with labeling indicia 106 and subsequently threaded over wires 102. In an embodiment, the inner surface of sleeves 104 can be coated with an adhering material prior to threading over wires 102. In such an embodiment, sleeves 104 are then adhered to the respective wire over which it is threaded.

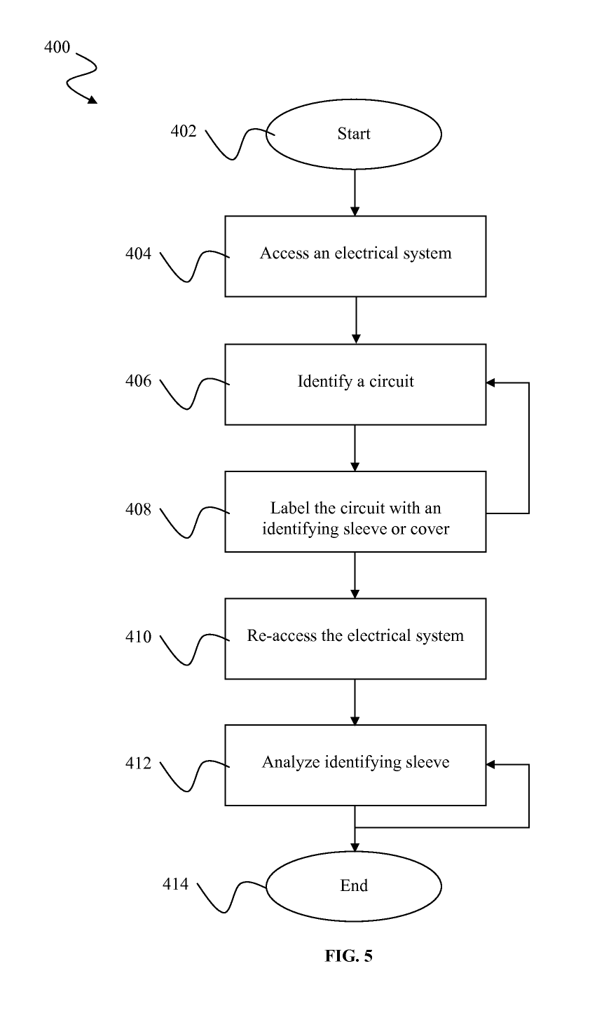

In operation, referring to FIG. 5, a method of identifying electrical wiring 400 according to an embodiment is depicted in a flowchart. Method 400 is useful where wiring has already been installed into a building and labeling sleeves 104 are subsequently retrofit onto the existing wiring 102. Beginning at 402, the method is initialized. At 404, an electrical system is accessed. For example, an electrician can be located at a centralized electrical panel, electrical box, fuse box, or breaker box and open any covering paneling in order to access the wiring 102 within. At 406, a particular circuit is identified. Circuit identification can be by myriad methods, including preexisting knowledge of the circuit, measurement of the electricity to a particular circuit, or trial-and-error, among others. Method 400 provides for only a single initial identification to be conducted, compared to above-described traditional methods where every time a panel is accessed, the circuit must be assessed. Once the circuit is identified, the circuit location is known relative to the building. The circuit wiring 102 can then be labeled with an identifying sleeve 104 or cover at 408. In embodiments, for example, as in an electrical wire identification kit, instructions are provided instructing a user to install the identifying sleeve 104 at the electrical system in accordance with the particular identifying sleeve 104. As described above, identifying sleeve 104 is coupled to wire 102. In embodiments, identifying sleeve 104 is slid and friction-fitted over wire 102, or heat shrunk onto wire 102, or otherwise adhered or affixed to wire 102. From 408, method 400 can return to 406 to subsequently identify another circuit within the electrical system. Steps 406 and 408 can be iteratively executed until all desired circuits are labeled with identifying sleeves 104. Referring then, to 410, the electrical system is re-accessed. Of course, the re-accessing of the electrical system can be immediate or even after a long period of time. At 412, a previously-affixed sleeve 104 is analyzed and subsequently linked or related to a particular circuit because of the labeling of the sleeve. Each identifying sleeve 104 can be analyzed by returning to step 412 until all desired circuits within the electrical system are identified. Thus, the particular circuits to which the covered wires 102 belong can be easily identified. The method 400 ends at 414.

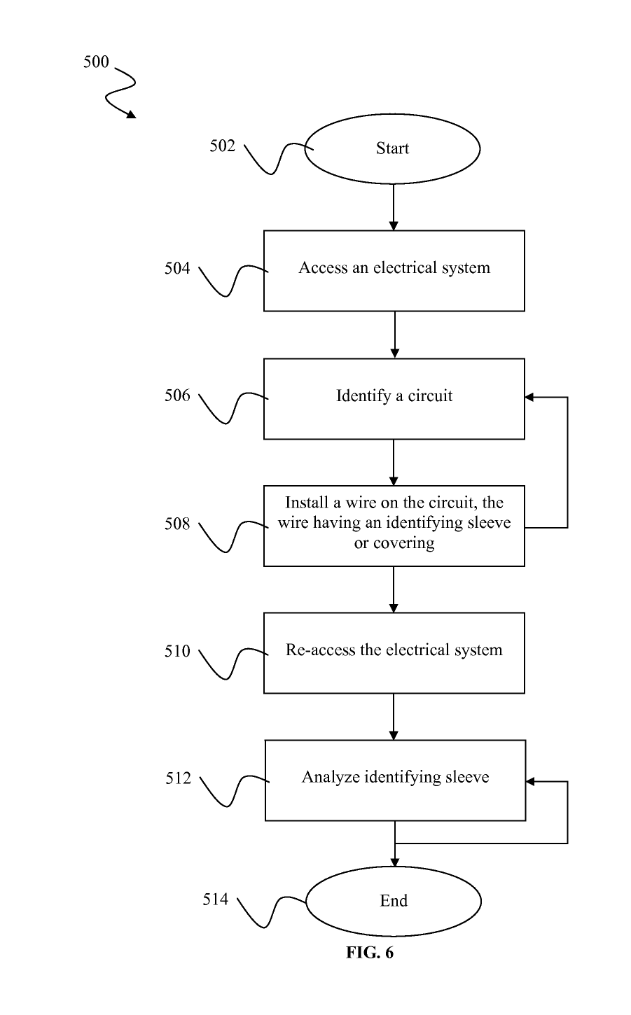

Referring to FIG. 6, a method of identifying electrical wiring 500 according to an embodiment is depicted in a flowchart. Method 500 is useful for the initial installation or whole re-wiring, into a building, of wiring 102 comprising identifying sleeves 104. Beginning at 502, the method is initialized. At 504, an electrical system is accessed similar to the access of the electrical system of 404, but instead, a centralized electrical box or fuse box where wiring 102 access points are to be installed is accessed. At 506, a particular circuit is identified. In method 500, the identification will likely be by knowledge of the installer, as wiring 102 installation into the centralized electrical box will be at the relatively same time as the installation of wiring 102 into the location of the building. At 508, a wire having an insulating sleeve 104, the sleeve 104 including indicia 106 indicating the particular just-installed circuit to which the electrical wire belongs is installed within the centralized electrical box. In embodiments, for example, as in an electrical wire identification kit, instructions are provided instructing a user to install the wire into a particular circuit. From 508, method 500 can return to 506 to subsequently identify another circuit within the electrical system. Steps 506 and 508 can be iteratively executed until all desired circuits are installed with wiring 102 having identifying sleeves 104. At 510, the electrical system is re-accessed. Just as with re-access 410, re-accessing of the electrical system 510 can be immediate or even after a long period of time. At 512, the previously-installed wiring with identifying sleeve 104 is analyzed and subsequently linked or related to a particular circuit because of the labeling of the sleeve 104. Each identifying sleeve 104 can be analyzed by returning to step 512 until all desired circuits within the electrical system are identified. Thus, the particular circuits to which the covered wires 102 belong can be easily identified. The method 500 ends at 514.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A system for identifying a room, space, or circuit of a structure, the system comprising:
a plurality of electrical wires; and
a plurality of identifying sleeves, each of the plurality of identifying sleeves configured to wrap around one or more of the plurality of electrical wires, thereby presenting an outer surface opposite the wrapped electrical wires,
wherein each of the plurality of identifying sleeves has a unique indicia printed on the outer surface corresponding to the room, space, or circuit of the one or more electrical wires.

2. The system of claim 1, wherein each of the plurality of indentifying sleeves comprises a heat-shrinkable material, and each of the plurality of indentifying sleeves is wrapped around the one or more of the plurality of electrical wires via the application of a heat source to the heat-shrinkable material when the heat-shrinkable material is proximate the one or more of the plurality of electrical wires.

3. The system of claim 1, wherein each of the plurality of indentifying sleeves comprises a plastic-based jacket, and each of the plurality of indentifying sleeves is wrapped around the one or more of the plurality of electrical wires via the threading of the one or more of the plurality of electrical wires through the identifying sleeve.

4. The system of claim 3, wherein the plastic-based jacket is unsecured to allow free movement along the one or more of the plurality of electrical wires over which the plastic-based jacket is wrapped.

5. The system of claim 3, wherein the plastic-based jacket is secured to the one or more of the plurality of electrical wires by an adhesive.

6. The system of claim 3, wherein the plastic-based jacket is secured to the one or more of the plurality of electrical wires by a mechanical fastener.

7. The system of claim 1, wherein each of the plurality of indentifying sleeves is made of an insulating material.

8. The system of claim 1, wherein the unique indicia are ink jet printed on each of the plurality of identifying sleeves.

9. The system of claim 1, wherein the unique indicia are permanently printed on each of the plurality of identifying sleeves.

10. The system of claim 1, wherein each of the plurality of identifying sleeves is further color-coded to identify the room, space, or circuit of the structure.

11. The system of claim 10, wherein the color-coding is standardized according to industry color codes.

12. An electrical wire identification kit, comprising:
a plurality of identifying sleeves, each of the plurality of identifying sleeves adapted to be wrapped around one or more of a plurality of electrical wires and comprising printed indicia corresponding to a room, space, or circuit of a structure; and
a container for storing the plurality of identifying sleeves.

13. The electrical wire identification kit of claim 12, further comprising instructions for instructing a user to install the plurality of identifying sleeves at an electrical supply source of the structure, wherein the container is further adapted to store the instructions.

14. The electrical wire identification kit of claim 12, wherein each of the plurality of identifying sleeves is further color-coded to identify the room, space, or circuit of the structure.

15. The electrical wire identification kit of claim 12, wherein the instructions include a schedule correlating a color to a specific room, space, or circuit.

16. The electrical wire identification kit of claim 12, further comprising a plurality of electrical wires, wherein each of the plurality of identifying sleeves is pre-wrapped around one or more of the plurality of electrical wires.

17. The electrical wire identification kit of claim 16, further comprising an electrical panel having the plurality of electrical wires installed, the container being further configured to store the electrical panel.

18. A method of identifying electrical circuits, the method comprising:
accessing an electrical system, the electrical system comprising a plurality of electrical circuits corresponding to rooms or spaces of a structure;
identifying an electrical circuit to be sourced at a particular room or space of the structure;
permanently labeling the electrical circuit with an identifying sleeve, the identifying sleeve comprising printed indicia corresponding to the identified room or space of the structure;
re-accessing the electrical system; and
analyzing the identifying sleeve to determine the source of the electrical circuit.

19. The method of claim 18, further comprising installing an electrical wire on the electrical circuit, wherein permanently labeling the electrical circuit with an identifying sleeve comprises installing the electrical wire with a pre-labeled identifying sleeve.

20. The method of claim 18, wherein permanently labeling the electrical circuit with an identifying sleeve further comprises color-coding the identifying sleeve.
